(19) United States
(12) Patent Application Publication
(10) Pub. No.: US 2002/0187908 A1
(43) Pub. Date: Dec. 12, 2002

(54) Process of cleaning carpets with a composition comprising a fluorinated compound

(75) Inventors: Leo Gagilardi, Saracena (IT); Stefano Scialla, Rome (IT)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/068,199

(22) Filed: Feb. 5, 2002

(30) Foreign Application Priority Data
Feb. 5, 2001 (EP) 01870018.7

(51) Int. Cl. C11D 1/00

(52) U.S. Cl. 510/278; 510/475

(57) ABSTRACT

The present invention relates to a process of cleaning a carpet comprising the steps of applying a liquid carpet cleaning composition onto a carpet using an electrically operated spraying device, leaving said composition to substantially dry onto said carpet and at least partially removing said composition preferably using a vacuum cleaner, wherein said composition comprises a fluorinated compound or a mixture thereof. The liquid carpet cleaning composition according to the present invention provides a carpet anti-resoiling performance benefit.

This application claims the benefit of the filing date of EPO patent application number 01870018.7, filed Feb. 5, 2001.

### TECHNICAL FIELD

The present invention relates to a process of cleaning carpets using a liquid composition. More particularly, the present invention relates to a process of cleaning carpets whereby good carpet anti-resoiling performance is achieved.

### BACKGROUND OF THE INVENTION

Carpets produced from synthetic or natural fibers and mixtures thereof are commonly used in residential and commercial applications as a floor covering. Various types of fibers can be used in making carpets such as polyamide fibers, polyester fibers as well as wool, cotton or even silk in the case of rugs.

Carpets irrespective of whether they are made from natural or synthetic fibers are all prone to soiling and staining. Foods, grease, oils, beverages such as coffee, tea and soft drinks, especially those containing acidic dyes, can cause unsightly, often dark stains on carpets. In addition, fibers may become soiled as a result of dirt particles, clay, dust, i.e., particulate soils in general, which may come into contact with and adhere to the fibers of the carpet. These latter soils often appear in the form of a diffuse layer of soils rather than in the form of spots and tend to accumulate particularly in the so called “high traffic areas” such as near doors as a result of intensive use of the carpets in such areas.

Compositions for cleaning carpets are already known in the art. Generally, three different classes of carpet cleaning compositions are known. A first class of compositions are so called ‘spotters’ that are used to remove spot stains from carpets. Such spotters are commonly sold in aerosol cans. Furthermore, spotters are used on smaller portions of the carpet to remove spot stains and due to limitations in relation to aerosol cans are not suitable for cleaning large portions of carpets. A second class of compositions are carpet shampoos for use in carpet extractor machines. Carpet cleaning using carpet extractor machines is a laborious process wherein a high amount of diluted shampoo is applied onto large areas of a carpet. During the cleaning of a carpet with an extractor machine said carpet is soaked with the diluted shampoo. A third class of carpet cleaning compositions are carpet cleaning compositions suitable to clean large carpet areas (“whole carpet cleaners”), wherein a liquid carpet cleaning composition is applied onto a carpet using spraying device and optionally left to substantially dry onto said carpet and/or removed from said carpet by, e.g., vacuuming the carpet, or a solid carpet cleaning composition is scattered over a carpet and afterwards removed from said carpet by, e.g., vacuuming the carpet. In addition to the above mentioned carpet cleaning compositions, it is known to treat carpets with specialized compositions providing a protection against soiling and/or staining, such as Stain Guard® compositions. Such a treatment is performed on new or thoroughly cleaned carpets and the compositions used therein are not intended to clean the carpets, but only to impregnate the carpets.

The present invention relates to the third class of carpet cleaners, the so called ‘whole carpet cleaners’, in particular to whole carpet cleaner in liquid form. The currently known liquid whole carpet cleaners are not fully satisfactory from a consumer viewpoint. In particular, the anti-resoiling properties imparted to the carpets cleaned therewith.

Therefore, improvements to such whole carpet cleaners have been suggested by providing whole carpet cleaners with a carpet anti-resoiling benefit, wherein soil repellency is imparted to a carpet cleaned with a whole carpet cleaner. For example, EP-A-997 526 and EP-A-949 326 describe carpet cleaning compositions providing a carpet anti-resoiling benefit.

Even though, the carpet cleaners according to the above cited art provide a good performance with regard to carpet anti-resoiling, it has been found by consumer research that the anti-resoiling properties imparted to the carpets cleaned with a whole carpet cleaning composition can be further improved. Indeed, consumers are looking for liquid carpet cleaning compositions that render a carpet first cleaned therewith even less prone to soil than the currently available compositions and thus further facilitate next-time cleaning operation.

It is therefore an objective of the present invention to provide a process of cleaning a carpet with a liquid carpet cleaning composition that will impart anti-resoiling properties to a carpet cleaned therewith.

Furthermore, it is an objective of the present invention to provide a process of cleaning a carpet which provides excellent overall cleaning performance on various types of stains and soils, including particulate stains and soils, greasy stains, bleachable stains and/or enzymatic stains.

It has now been found that the above objects can be met by a process of cleaning a carpet according to the present invention.

An advantage of the present invention is that the anti-resoiling benefit of the compositions herein is particularly good with regard to preventing the resoiling of carpets cleaned according to a process as described herein with particulate soils, such as dirt particles, clay, dust, etc.

A further advantage of the present invention is that the process herein provides an easy and fast way of cleaning a carpet.

Still a further advantage of the present invention is that the process of cleaning a carpet herein is applicable to all carpet types, especially delicate natural fibers, and is also safe to all carpet dye types, particularly sensitive natural dyes used therein. The present invention is also suitable to be used to clean upholstery and car seats covering.

Yet another advantage of the present invention is that the composition herein may be applied directly on the carpet without causing damage to the carpet.

### BACKGROUND ART

The following documents are representative of the prior art available on carpet cleaning compositions.

WO 98/14540 describes a composition comprising a fluorosurfactant. The composition is applied onto a carpet using an extractor machine.

U.S. Pat. No. 5,861,365 describes a composition for imparting oil and water repellency to a treated surface, the composition comprises a fluoroaliphatic radical-containing poly (oxyalkylene) compound. '365 describes the application of the composition onto the carpet using a manually operable pump sprayer or a pressurised sprayer.

WO 98/31777 describes an acidic composition comprising a urethane perfluoroalkyl ester constituent and an oxidising agent. '777 describes the application of the composition onto the carpet using a manually operable pump sprayer or a pressurised sprayer.

EP-A-0 949 326 describes a process of cleaning a carpet with a liquid composition comprising an anti-resoiling agent, said process comprising the steps of applying said composition to the surface of the carpet and leaving said composition to dry onto the carpet.

EP-A-0 997 526 describes a process of cleaning a carpet with a liquid composition comprising a peroxygen bleach and an N-vinyl polymer, said process comprising the steps of applying said composition to the surface of the carpet and leaving said composition to dry onto the carpet.

### SUMMARY OF THE INVENTION

The present invention encompasses a process of cleaning a carpet comprising the steps of applying a liquid carpet cleaning composition onto a carpet using an electrically operated spraying device, leaving said composition to substantially dry onto said carpet and at least partially removing said composition, preferably using a vacuum cleaner, wherein said composition comprises a fluorinated compound.

In a preferred embodiment said composition further comprises a peroxygen bleach.

The present invention also encompasses a composition comprising a fluorinated compound, a peroxygen bleach and a radical scavenger.

### DETAILED DESCRIPTION OF THE INVENTION

### Process of Cleaning a Carpet

The present invention encompasses a process of cleaning a carpet comprising the steps of applying a liquid composition onto said carpet using an electrically operated spraying device, leaving said composition to substantially dry onto said carpet and at least partially removing said composition, preferably using a vacuum cleaner, wherein said composition comprises a fluorinated compound.

Preferably, in the process of cleaning a carpet herein the step of at least partially removing said composition includes the removal of said composition in combination with soil particles.

In a preferred embodiment, the process herein comprises the steps of applying said composition onto the carpet, mechanically agitating the composition, preferably with an implement, into the soiled parts of the carpet layer and leaving said composition to substantially dry on the carpet. Any number of implements may be used to provide said mechanical agitation, including brushes, sponges, paper towels, a cleaning glove, a human finger and the like. In a preferred embodiment said implement is attached and/or attachable to the spraying device used in the process of the present invention. Said mechanical agitation allows the liquid composition to better penetrate into the carpet fibers and thus improves the chemical cleaning action of said composition. In addition, said contact loosens the dirt particles forming the stain.

In the process according to the present invention, the composition is applied onto the carpet using an electrically operated spraying device. Said spraying device is preferably a container that has at least one aperture through which the composition is dispensed to produce a spray of droplets.

Such an electrically operated spraying device may comprise a means for delivering the composition by a pump (“pump spray dispenser”). Electrically operated pump spray dispensers are particularly preferable for large areas of carpets to be cleaned. Indeed, said electrically operated pump spray dispensers ensure uniform coverage of the area to be cleaned. It has been found by the Applicant that uniform coverage is an essential requirement for providing the benefit of rendering a carpet first cleaned with the composition herein less prone to soil and thus facilitating next-time cleaning operation, uniformly over a large, consecutive area of carpet.

Preferred electrically operated spraying devices herein are electrically operated pump spray dispensers.

Spraying devices operated by any source of pressurised gas (“pressurised devices”) such as an aerosol-can, a pressurizer or a carbonater are not suitable for use herein. Indeed, it has been found that in some instances in a pressurised device the ingredients of the compositions stored therein are not sufficiently stable due to the elevated pressure conditions in said devices and/or during the application of said composition onto a carpet. Furthermore, aerosol-cans are limited in the amount of product that can be packaged therein. Indeed, an aerosol-can including sufficient product to clean large areas of carpet has to comprise high amounts of propellant. The combination of high amounts of product and propellant requires a high volume aerosol-can, which is too heavy and/or bulky for practical use by a person cleaning a carpet.

A preferred electrically operated pump spray dispensers (“electrical spraying device”) herein is a container wherein the means for delivering the composition comprises an electrically driven pump and a spray arm. Said spray arm is preferably either elongated or extendible and has at least one aperture so that in operation, the composition is pumped by said electrically driven pump from the container, through the spray arm to the aperture from which it is dispensed. It is preferred that the spray arm communicates with the container by means of a flexible connector. The spray arm may have at least one aperture located along its length. The spray arm allows the user to exert control over the trajectory of the sprayed composition, thereby increasing the accuracy with which the composition is applied. The electrically driven pump may be, for example, a gear pump, an impeller pump, a piston pump, a screw pump, a peristaltic pump, a diaphragm pump, or any other miniature pump. In a highly preferred embodiment the electrically driven pump for use herein is a gear pump with a typical speed between 6000 rpm and 12000 rpm. The electrically driven pump is driven by any means which typically produces a torque of between 1 and 20 mN*m such as an electric motor. The electric motor must in turn be provided with a power source. The power source may be either mains electricity (optionally via transformer), or it may be a throw-away battery or rechargeable battery. The spray arm may be rigidly elongated. However such a spray arm can be difficult to store, and the spray arm is preferably extendible either by means of telescopic or foldable configuration.

Any container adapted to deliver a spray of droplets as defined herein is suitable for use herein. Several modifications can be made to the conventional, single aperture, spray head to ensure that a spray of such droplets as are required herein are formed.

The amount of the composition required for the cleaning of carpets according to the present invention will depend on the severity of the staining or soiling of said carpet. In the case of stubborn stains, more than one application may be required to ensure complete removal of the stain. In a preferred embodiment, up to 300 ml, preferably of from 5 ml to 200 ml, more preferably of from 10 ml to 150 ml, even more preferably of from 15 ml to 100 ml, and most preferably of from 20 ml to 90 ml of carpet cleaning composition is applied per 1 m² of carpet to be cleaned.

The area to be cleaned upon the compositions according to the present invention is applied, may be of any size. In a preferred embodiment, the process according to the present invention is used to clean consecutive areas of carpet (“whole carpet cleaner”). By “cleaning consecutive areas of carpet” it is meant herein, that in the process herein a liquid composition is applied onto a, preferably large, continuous part of the carpet and not only to an isolated spot of said carpet. Preferably, in the process according to the present invention the liquid composition is applied to at least 50%, preferably at least 75%, even more preferably at least 80%, and most preferably at least 90% of a carpet area in a room.

In the process herein, the composition applied to the carpet is left to substantially dry onto said carpet. Typically, the composition is left to dry on the carpet for less than 24 hours, preferably less than 4 hours, more preferably less than 2 hours, even more preferably from 1 to 2 hours and most preferably from 30 to 60 minutes.

Preferably the step of leaving the composition to dry onto the carpet (drying step) can either be an “active drying step” or a “passive drying step”. By “active drying step” it is meant herein, performing an additional action to facilitate the evaporation of the volatile ingredients of the liquid composition as disclosed herein, preferably by heating the carpet and/or the liquid composition applied thereon, preferably heating by means of application of hot air, infrared radiation and the like. By “passive drying step” it is meant herein, evaporation of the volatile ingredients of the liquid composition as disclosed herein without performing further action.

By “substantially dry” it is meant herein the stage where at least 40%, preferably at least 60% of the initial amount of composition dispensed onto the carpet is lost due to evaporation.

The step of leaving the composition to dry on the carpet is of course performed under “normal temperature” and “normal humidity conditions”. By “normal temperature conditions” it is meant herein, from 15° C. to 30° C., preferably from 18° C. to 25° C. By “normal humidity conditions” it is meant herein, from 40% RH (%-relative humidity) to 80% RH, preferably from 50% RH to 65% RH.

Indeed, said composition may be left to substantially dry until said composition combined with dirt forms substantially dry residues. Preferably, said composition, more preferably said substantially dry residues, are then removed from the carpet. Even more preferably said substantially dry residues are removed mechanically, as e.g., by brushing, sweeping beating, and/or by vacuum cleaning. Most preferably, said substantially dry residues are removed mechanically by vacuum cleaning. This may be carried out with the help of any commercially available vacuum cleaner like for instance a standard Hoover® 1300W vacuuming machine.

According to the present invention the compositions herein may be used for the removal of stains and soils as well as of odors from carpets or hard wearing textiles and fabrics, e.g., upholstery. In addition the compositions according to the present invention may be used to hygienise, disinfect and/or exterminate microinsects from carpets or hard wearing textiles and fabrics, e.g., upholstery, rugs, curtains.

### The Composition

The compositions of the present invention are formulated as liquid compositions. Preferred compositions herein are aqueous compositions and therefore, preferably comprise water, more preferably in an amount of from 60% to 98%, even more preferably of from 80% to 97% and most preferably 85% to 97% by weight of the total composition.

The pH of the liquid compositions according to the present invention may typically be from 1 to 14. Preferably, the pH of the liquid compositions herein, as is measured at 25° C., is at least, with increasing preference in the order given, 0.1, 0.5, 1, 1.5, 2, 2.5, 3, 3.5, 4, 4.5, 5, 5.5, 6 or 6.5. Independently, the pH of the liquid compositions herein, as is measured at 25° C., preferably is no more than, with increasing preference in the order given, 14, 13.5, 13, 12.5, 12, 11.5, 11, 10.5, 10, 9.5, 9, 8.5, 8, 7.5 or 7. Accordingly, the compositions herein may further comprise an acid or base to adjust pH as appropriate.

In a preferred embodiment wherein the compositions herein comprise a peroxygen bleach, the pH of the liquid compositions, as is measured at 25° C., is typically at least, with increasing preference in the order given, 0.1, 0.5, 1, 1.5, 2, 2.5, 3, 3.5, 4 or 4.5. Independently, the pH of said preferred liquid compositions comprising a peroxygen bleach as described herein, as is measured at 25° C., preferably is typically no more than, with increasing preference in the order given, 10, 9.5, 9, 8.5, 8, 7.5, 7, 6.5, 6 or 5.5. These preferred pH ranges contribute to the stability of hydrogen peroxide, when present.

Preferred acids herein are organic or inorganic acids or mixtures thereof. Preferred organic acids are acetic acid, or citric acid or a mixture thereof. Preferred inorganic acids are sulfuric acid or phosphoric acid or a mixture thereof. A particularly preferred acid to be used herein is an inorganic acid and most preferred is sulfuric acid.

Typical levels of such acids, when present, are of from 0.01% to 1.0% by weight, preferably from 0.05% to 0.8% and more preferably from 0.1% to 0.5% by weight of the total composition.

The bases to be used herein can be organic or inorganic bases. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate and hydrogen carbonate.

Typical levels of such bases, when present, are of from 0.01% to 1.0% by weight, preferably from 0.05% to 0.8% and more preferably from 0.1% to 0.5% by weight of the total composition.

### Fluorinated Compound

As an essential ingredient the liquid compositions according to the present invention comprise a fluorinated compound or a mixture thereof. Any fluorinated compound known to those skilled in the art providing the benefit of rendering a carpet first cleaned with a composition less prone to soil and thus facilitating next-time cleaning operation (“anti-resoiling performance/benefit”) may be used in the compositions employed in the process according to the present invention. Preferably, the fluorinated compound herein is a fluorinated anti-resoiling compound. By “fluorinated anti-resoiling compound” it is meant herein, any compound providing an anti-resoiling benefit to the compositions used in the process herein.

Suitable fluorinated compounds herein are selected from the group consisting of fluoropolymers and fluorosurfactants and mixtures thereof.

Suitable fluoropolymers are polymers or compounds having pendent or end groups of perfluoroalkyl moieties, such as fluorinated polyacrylates; fluorinated polymethacrylates; fluorinated copolymers including acrylic and/or methacrylic and/or maleic monomers; fluorinated urethanes; fluorinated polyurethanes; and mixtures thereof.

In a preferred embodiment according to the present invention, said fluorinated compound is a fluoropolymer. Preferably, the fluorinated compound herein is a fluorinated polyacrylate, polymethacrylate, urethane or polyurethane.

By “fluorinated polyacrylates” it is meant herein any polymer of acrylic acid carrying pendent or end groups of polyfluoroalkyl moieties. By “fluorinated polymethacrylates” it is meant herein any polymer of methacrylic acid carrying pendent or end groups of polyfluoroalkyl moieties. By “fluorinated copolymers including acrylic and/or methacrylic and/or maleic monomers” it is meant herein any copolymer of acrylic acid and/or methacrylic acid and/or maleic acid carrying pendent or end groups of polyfluoroalkyl moieties.

Preferably, said polyfluoroalkyl moiety is a linear or branched polyfluoroalkyl group having from 1 to 20 carbon atoms, preferably from 1 to 16, even more preferably from 3 to 12. Preferably, the polyfluoroalkyl group according to the above description is a perfluoroalkyl group. Typically, the polyfluoroalkyl moiety has the following structure:

CF₃—(CF₂)ₙ—CH₂—CH₂—

wherein n ranges from 0 to 20, preferably from 1 to 16, more preferably from 2 to 12, even more preferably from 3 to 10, and is esterified with some or all of the carboxylic groups of the fluorinated polyacrylates, fluorinated polymethacrylates or fluorinated copolymers including acrylic and/or methacrylic and/or maleic monomers.

Preferably, the fluorinated polyacrylates, fluorinated polymethacrylates and fluorinated copolymers including acrylic and/or methacrylic and/or maleic monomers have a molecular weight of from 500 to 200,000, more preferably from 1,000 to 150,000, and even more preferably from 1,500 to 100,000.

Suitable fluorinated polyacrylates are commercially available under the trade name Syntran 4010E® from Interpolymer; Asahi Guard AG-70000®, Asahi Guard AG-8095®, and Asahi Guard AG-1100®, all from Asahi Glass Co., Ltd.

By “fluorinated urethanes” it can be meant any compound, which is an ester of carbamic acid carrying a polyfluoroalkyl moiety. The polyfluoroalkyl moiety can be attached to the rest of the molecule either through an ester bond, or through a bond with the nitrogen atom of carbamic acid. Typically, the perfluoroalkyl moiety has the following structure:

CF₃—(CF₂)ₙ—CH₂—CH₂—

wherein n ranges from 0 to 20, preferably from 1 to 15, more preferably from 2 to 10, even more preferably from 2 to 8.

Preferably, the fluorinated urethanes have the following structure:

R₁ R₂N—CO—O—R₃

wherein any of R₁, R₂, R₃ can be a hydrogen, or a linear or branched saturated or unsaturated alkyl group, or a cycloalkyl group, or an aryl group, or a substituted alkyl or aryl group; and at least one of R₁, R₂, R₃ is a perfluoroalkyl moiety having the above described structure.

By “fluorinated urethanes or polyurethanes” it is meant herein any compound, polymer or copolymer synthesized from at least the following components: 1) a bifunctional or polyfunctional isocyanate; and 2) a compound or monomer containing a polyfluoroalkyl group.

Specific examples of bifunctional isocyanate compounds are aromatic isocyanates such as 2,4-tolylene diisocyanate, tolidine diisocyanate, 4,4′-diphenylmethane diisocyanate, dianisidine diisocyanate, 2-methyl-cyclohexane 1,4-diisocyanate, isophorone diisocyanate, and aliphatic isocyanates such as hexamethylene diisocyanate or decamethylene diisocyanate. If these isocyanates are represented by the general formula OCN—Y—NCO (wherein Y stands for any aromatic or aliphatic group), and if OCN—Y—NCO is reacted by itself in the presence of water, a dimer of formula OCN—Y—NHCONH—Y—NCO will be formed. The bifunctional isocyanate compound includes such a dimer.

Polyfunctional isocyanate compounds include, for example, trifunctional, tetrafunctional and pentafunctional isocyanates. In addition, two or more isocyanate compounds having different bi- or polyfunctionalities may be used in combination in the same fluorinated polyurethane. Specific examples of trifunctional isocyanate compounds are given below. As mentioned above for the bifunctional isocyanate compounds, however, the trifunctional isocyanate compound further includes compounds having tri-NCO groups such as a trimer of formula

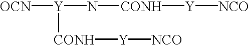

obtainable by reaction of a monomer of formula OCN—Y—NCO with a dimer of the formula OCN—Y—NHCONH—Y—NCO, and a tetramer of formula

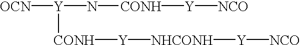

obtainable by reaction of two molecules of such a dimer.

Specific examples of such a trifunctional isocyanate compound include the following compounds:

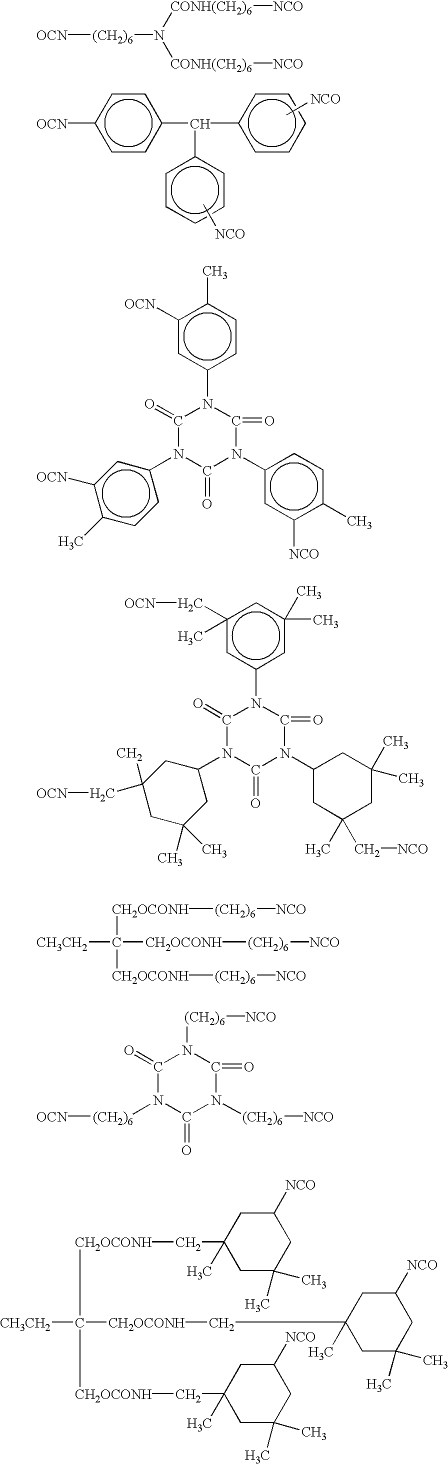

Specific examples of monomers or compounds containing a polyfluoroalkyl group are according to the following formulae:

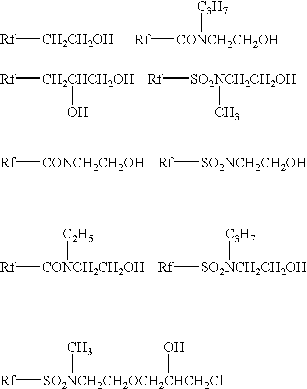

wherein Rf is a linear or branched polyfluoroalkyl group having from 1 to 20 carbon atoms, preferably from 2 to 16, even more preferably from 3 to 12. Other examples of monomers or compounds include esters of polyfluoroalkyl alcohols; polyfluoroalkyl amines; and in general any compound that includes a polyfluoroalkyl radical and carries one or more functional groups having one or more Zerewitinoff hydrogen atoms¹. ¹Zerewitinoff et al. method: an active hydrogen-containing organic compound (—OH, —COOH, —NH, etc.) is reacted with a CH₃Mg halide to liberate CH₄ which, measured volumetrically, gives a quantitative estimate of the active hydrogen content of the compound. Primary amines give 1 mol of CH₄ when reacted in the cold; usually two mols when heated (Organic Chemistry by Paul Karrer, English Translation published by Elsevier 1938, page 135).

Two or more different kinds of these compounds may be used in combination. Further, two or more compounds having different carbon numbers for Rf may be used in combination. Preferably, the polyfluoroalkyl group according to the above description is a perfluoroalkyl group.

The fluorinated polyurethanes according to the present invention may also include other monomers, for instance to improve the efficiency of their synthesis, or to impart certain mechanical characteristics to the final material obtained. These additional monomers are described in the prior art, for instance examples are given in EP-A-0 414 155 (Asahi Glass Company LTD).

Fluorinated urethane compounds suitable for the present invention are described also in U.S. Pat. No. 5,565,564 to Du Pont de Nemours and Company.

Suitable fluorinated urethanes or polyurethanes are commercially available for example under the trade name Asahi Guard AG-320A®, Asahi Guard AG-850®, Asahi Guard AG-530N®, all from Asahi Glass Co., Ltd.; and under the trade name Zonyl 1250 ® from DuPont De Nemours Inc. Suitable fluorinated polymers are also urethane perfluoroalkyl ester compounds such as Zonyl TBCU-A® from DuPont De Nemours Inc.

Suitable fluorosurfactants are, for example, selected from the group consisting of: fluoroalkyl carboxylates; fluoroalkyl sulphates; fluoroalkyl sulphonates; fluoroalkyl phosphates; fluoroalkyl polyethoxyalcohols; fluoroalkyl ammonium; fluoroalkyl betaines or sulphobetaines or other zwitterionic forms; and mixtures thereof.

In a preferred embodiment according to the present invention, said fluorinated compound is a fluorosurfactant. Preferably, the fluorinated compound herein is a fluorosurfactant selected from the group consisting of: fluoroalkyl carboxylates; fluoroalkyl sulphates; fluoroalkyl sulphonates; fluoroalkyl phosphates; fluoroalkyl phosphonates; fluoroalkyl polyethoxyalcohols; fluoroalkyl ammonium; fluoroalkyl betaines or sulphobetaines or other zwitterionic forms; and mixtures thereof.

In a preferred embodiment, the general structure of fluorosurfactants suitable for the present invention is:

Rf—CH₂ —CH₂—X

wherein Rf is a linear or branched polyfluoroalkyl group having from 1 to 20 carbon atoms, preferably from 2 to 16, even more preferably from 3 to 12. Preferably, the polyfluoroalkyl group according to the above description is a perfluoroalkyl group. The functional group X can be any of the above listed functional groups, for example —SO₃⁻; —OSO₃⁻; —OPO₃²⁻; —PO₃²⁻; —COO⁻; —O(CH₂CH₂)ₙH, wherein n can range from 1 to 50, preferably from 2 to 20; —N^{+R}₁R₂R₃, wherein any of R₁, R₂, R₃ can be a linear or branched saturated or unsaturated alkyl group, or a cycloalkyl group, or an aryl group, or a substituted alkyl or aryl group, preferably an alkyl group and even more preferably a methyl group.

Other preferred fluorosurfactant structures according to the present invention are according to the following formulae:

(R_{f}CH₂CH₂O)ₓPO(O—NH₄⁺)_{y}; x+y=3

(R_{f}CH₂CH₂O)ₓPO(O—NH₄⁺)_{y}(OCH₂CH₂OH)_{z} ; x+y+z=3

(R_{f}CH₂CH₂O)ₓPO(O—NH₂(CH₂CH₂OH)₂⁺)_{y}; x+y=3

R_{f}CH₂CH₂SCH₂CH₂COO⁻Li⁺

R_{f}CH₂CHO(Ac)CH₂N⁺(CH₃)₂CH₂COO⁻

(⁻OOC)ₓ(R_{f}CH₂CH₂OOC)_{y}C₃H₅O(Citrate) ; x+y=3

wherein Rf is a linear or branched polyfluoroalkyl group having from 1 to 20 carbon atoms, preferably from 2 to 16, even more preferably from 3 to 12.

Typical countercations for anionic functional groups of fluorosurfactants according to the present invention is H⁺or a metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Typical counteranions for cationic functional groups of fluorosurfactants according to the present invention are, for example, chloride, fluoride, bromide, sulphate, nitrate, mesilate, acetate, citrate and the like. Any countercation and counteranion that does not have a negative impact on the antiresoiling properties of the fluorosurfactants according to the present invention may be used.

Suitable fluorosurfactants are commercially available for example under the trade name Zonyl FSP®, Zonyl FSE®, Zonyl FSJ®, Zonyl NF®, Zonyl TBS®, Zonyl FS-62®, Zonyl FSA®, Zonyl FSK®, Zonyl 7950®, Zonyl 9075®, Zonyl FSO®, Zonyl FSN®, Zonyl FS-300®, Zonyl FS-310®, Zonyl FSN-100®, Zonyl FSO-100®, all available from DuPont De Nemours Inc.; Fluorad® fluorosurfactants from 3M Inc.; Surflon® fluorosurfactants from Asahi Glass Co., Ltd.

Typically, the liquid compositions herein comprise from 0.0001% to 10%, preferably from 0.0005% to 7%, more preferably from 0.001% to 5%, and even more preferably from 0.01% to 0.5% by weight of the total composition of a fluorinated compound or a mixture thereof.

It has now been found that when fluorinated compounds, as described herein are added into liquid compositions, a film, i.e., a layer of these agents is left on the carpet fibers cleaned with said composition. The film reduces adhesion of soils and/or stains onto said carpet fibers cleaned with the composition according to the present invention and/or facilitates removal of soils and/or stains subsequently deposited thereon. Thus, less effort (e.g., less vacuum cleaning and/or less chemical action) is required to remove the soils/stains in the next cleaning operation (“carpet anti-resoiling performance/benefit”), as compared to the cleaning of a similarly soiled/stained carpet which has been first cleaned with the same composition but wherein a different anti-resoiling agent, such as for example described in EP-A-0 997 526 and EP-A-0 949 326, is present or wherein an anti-resoiling agent is absent.

It has been found that in particular the carpet anti-resoiling benefit can observed in relation to particulate soils, such as clay, dust, dirt particles, etc.

Moreover, it has been found that by applying the composition comprising a fluorinated compound onto a carpet to be cleaned using an electrically operated spraying device, a uniform coverage of said composition over the carpet, preferably the whole carpet or at least large, consecutive areas of the carpet, can be achieved (see paragraph “Process of cleaning a carpet”). This ensures that the resoiling that eventually will occur, even though significantly reduced as compared to a carpet first cleaned with the same composition but wherein a different anti-resoiling agent is present or wherein an anti-resoiling agent is absent, will be uniform as well. A non-uniform resoiling could lead to the formation of dingy areas on the carpet whereon the resoiling took place faster as compared to other areas that will appear less dingy. This faster resoiling of the dingy areas is due to a lower amount of fluorinated compound deposited on said area due to a non-uniform coverage. Such a non-uniform resoiling is disadvantageous, as it will require the next cleaning action of the carpet earlier than necessary. Indeed, even though parts of the carpet are still substantially clean, the whole carpet will need to be cleaned to remove the dingy areas that formed on said carpet. It is well known by those skilled in the art, that every cleaning action has a negative effect on the carpet. Indeed, the more a carpet is cleaned the shorter will its lifespan be. The present invention substantially prevents the non-uniform resoiling of a carpet by ensuring a uniform application of the cleaning composition onto the carpet. Therefore, due to less frequent requirement to clean a carpet, the lifespan of a carpet cleaned according to a process as described herein is extended. Furthermore, the overall use of product is reduced due to less frequent requirement to clean a carpet, which is an economical benefit as well as an ecological benefit.

Furthermore, it has been found that the presence of a fluorinated compound in the compositions herein further contributes to the overall cleaning performance (“carpet cleaning benefit”) of the compositions herein.

The compositions employed in the process of cleaning carpets according to the present invention provide a carpet anti-resoiling benefit and a carpet cleaning benefit on various types of soils including diffuse soils (e.g., particulate and/or greasy soils) that tend to accumulate in the so called “high traffic areas” but also in delivering a carpet anti-resoiling benefit and a carpet cleaning benefit on other types of stains or soils, e. g., proteinic stains like blood or beverage stain like coffee.

By “high traffic areas” it is meant herein areas with an intensive use of the carpets in such areas as for example near doors.

By “particulate soils” it is meant herein any soils or stains of particulate nature that can be found on any carpet, e.g. clay, dirt, dust, mud, concrete and the like.

By “greasy/oily soils” it is meant herein any soils or stains of greasy/oily nature that can be found on any carpet, e.g., make-up, lipstick, dirty motor oil and mineral oil, greasy food like mayonnaise and spaghetti sauce.

By “proteinic stains” it is meant herein any soils or stains of proteinic nature that can be found on any carpet, e.g., grass.

By “beverage stains” it is meant herein any soils or stains of hydrophilic nature that can be found on any carpet, e.g., coffee, wine, tea.

The carpet cleaning benefit, of a carpet cleaning composition can be assessed by the following test method: A liquid composition according to the present invention is first sprayed, onto the stained portion of a carpet, left to act thereon from 1 to 60 minutes, preferably 30 minutes, after which the carpet is vacuum cleaned using any commercially available vacuum cleaners like for instance a standard Hoover® 1300W vacuuming machine. The soils used in this test may be particulate stains, greasy/oily stains or proteinic stain as described above. The carpet cleaning benefit of said carpet cleaning composition can be assessed by visual grading. The visual grading may be performed by a group of expert panelists using panel score units (PSU). To asses the carpet cleaning benefit of a given composition a PSU-scale ranging from 0, meaning no noticeable difference in cleanliness of a cleaned, initially soiled, carpet versus an uncleaned, similarly soiled, carpet, to 4, meaning a clearly noticeable difference in cleanliness of a cleaned, initially soiled, carpet versus an uncleaned, similarly soiled, carpet, can be applied.

The carpet anti-resoiling performance/benefit of a given composition on a soiled carpet may be evaluated by the following test methods (as described in WO96/18765):

### 1) OIL REPELLENCY TEST

The oil repellency of carpets cleaned according to the present invention can be measured by the American Association of Textile Chemists and Colorists (AATCC) Standard Test Method No. 118-1983, which test is based on the resistance of cleaned carpet to penetration by oils of varying surface tensions. Cleaned carpets resistant only to Kaydol®, a brand of mineral oil and the least penetrating of the test oils, are given a rating of 1, whereas cleaned carpets resistant to heptane (the most penetrating of the test oils) are given a value of 8. Other immediate values are determined by use of other pure oils or mixtures of oils, as shown in the following table:

STANDARD TEST LIQUIDS

| AATCC OIL REPELLENCY RATING | |
|---|---|
| NUMBER | COMPOSITION |
| 1 | Kaydol ™ |
| 2 | 65:35 Kaydol ™: hexadecane by |
| | volume at 21° C. |
| 3 | n-hexadecane |
| 4 | n-tetradecane |
| 5 | n-dodecane |
| 6 | n-decane |
| 7 | n-octane |
| 8 | n-heptane |

The rated oil repellency corresponds to the most penetrating oil (or mixture of oils), which does not penetrate or wet the carpet after ten seconds contact. Higher numbers indicate better oil repellency. In the test procedure the sample is placed on a flat surface. A dropper pipette is used to gently place five drops of the selected oil onto the sample at 5 cm intervals. After ten seconds, if four out of five drops are still visible, the sample passes the test. A rating of ‘2’is generally considered a minimum requirement.

### 2) WATER REPELLENCY TEST

The aqueous stain or water repellency of cleaned carpets is measured using a water/isopropyl alcohol test, and the result is expressed in terms of a water repellency rating of the cleaned carpet. Cleaned carpets which are resistant to a 100% water/0% isopropyl alcohol mixture (the least penetrating of test mixtures) are given a rating of W; resistance to a 90% water/10% isopropyl alcohol mixture is given a rating of 1, whereas cleaned carpets resistant to 0% water/100% isopropyl alcohol mixture (the most penetrating of the test mixtures) are given a rating of 10. Other intermediate values are determined by use of other water/isopropyl alcohol mixtures, in which the percentage amounts of water and isopropyl alcohol are each multiples of ten. Results are reported as an average of replicate testing. The water repellency rating corresponds to the most penetrating mixture, which does not penetrate or wet the carpet after ten seconds. The procedure involves placing five small drops of water/alcohol mixture onto the carpet face. After ten seconds, if four out of five drops are still visible, the sample passes the test. A rating of ‘1’(90/10 water/isopropanol mixture) is generally considered as a minimum requirement.

### 3) DRY SOIL REPELLENCY

This test is intended to measure the tendency of a carpet to resist dry soil during the use. The soil contains clay, carbon black, silica and mineral oil. It is deposited onto the carpet via a soil capsule in a tumbler containing seventy steel balls. The tumbler rotates for ten minutes and the carpet samples are removed and the excess soil is blown off by an air nozzle at 50 psi. The degree of soiling resistance is measured by comparing the soiled area to a standard rating board. A 5.0 rating is the absolute standard of soil repellency and 3.0 is an acceptable soiling degree.

### Optional Ingredients

### Peroxygen Bleach

As an optional but highly preferred ingredient the compositions according to the present invention may comprise a peroxygen bleach.

Suitable peroxygen bleaches to be used herein are selected from the group consisting of: hydrogen peroxide; water soluble sources of hydrogen peroxide; organic or inorganic peracids; hydroperoxides; diacyl peroxides; and mixtures thereof.

As used herein a hydrogen peroxide source refers to any compound that produces perhydroxyl ions when said compound is in contact with water. Suitable water-soluble sources of hydrogen peroxide for use herein are selected from the group consisting of percarbonates, perborates and persilicates and mixtures thereof.

Suitable diacyl peroxides for use herein are selected from the group consisting of aliphatic, aromatic and aliphatic-aromatic diacyl peroxides, and mixtures thereof.

Suitable aliphatic diacyl peroxides for use herein are dilauroyl peroxide, didecanoyl peroxide, dimyristoyl peroxide, or mixtures thereof. A suitable aromatic diacyl peroxide for use herein is for example benzoyl peroxide. A suitable aliphatic-aromatic diacyl peroxide for use herein is for example lauroyl benzoyl peroxide. Such diacyl peroxides have the advantage to be particularly safe to carpets and carpet dyes while delivering excellent bleaching performance.

Suitable organic or inorganic peracids for use herein are selected from the group consisting of: persulphates such as monopersulfate; peroxyacids such as diperoxydodecandioic acid (DPDA) and phthaloyl amino peroxycaproic acid (PAP); magnesium perphthalic acid; perlauric acid; perbenzoic and alkylperbenzoic acids; and mixtures thereof.

Suitable hydroperoxides for use herein are selected from the group consisting of tert-butyl hydroperoxide, cumyl hydroperoxide, 2,4,4-trimethylpentyl-2-hydroperoxide, di-isopropylbenzene-monohydroperoxide, tert-amyl hydroperoxide and 2,5-dimethyl-hexane-2,5-dihydroperoxide and mixtures thereof. Such hydroperoxides have the advantage to be particularly safe to carpets and carpet dyes while delivering excellent bleaching performance.

Preferred peroxygen bleaches herein are selected from the group consisting of: hydrogen peroxide; water-soluble sources of hydrogen peroxide; organic or inorganic peracids; hydroperoxides; and diacyl peroxides; and mixtures thereof. More preferred peroxygen bleaches herein are selected from the group consisting of hydrogen peroxide, water-soluble sources of hydrogen peroxide and diacyl peroxides and mixtures thereof. Even more preferred peroxygen bleaches herein are selected from the group consisting of hydrogen peroxide, water-soluble sources of hydrogen peroxide, aliphatic diacyl peroxides, aromatic diacyl peroxides and aliphatic-aromatic diacyl peroxides and mixtures thereof. Most preferred peroxygen bleaches herein are hydrogen peroxide, water-soluble sources of hydrogen peroxide or mixtures thereof.

Typically, the liquid compositions herein comprise from 0.01% to 20%, preferably from 0.5% to 10%, and more preferably from 1% to 7% by weight of the total composition of a peroxygen bleach, or mixtures thereof.

The presence of a peroxygen bleach in preferred compositions employed in the process of cleaning a carpet according to the present invention contributes to the excellent cleaning and sanitizing performance on various types of soils including on spot stains like bleachable stains (e.g., coffee, beverage, food) of the compositions of the present invention.

By “bleachable stains” it is meant herein any soils or stains containing ingredients sensitive to bleach that can be found on any carpet, e.g., coffee or tea.

### Surfactants

As an optional but highly preferred ingredient the compositions according to the present invention may comprise a surfactant or a mixture thereof.

Typically, the compositions herein may comprise up to 50%, preferably from 0.1% to 20%, more preferably from 0.5% to 10% and most preferably from 1% to 5% by weight of the total composition of a surfactant.

Such surfactants may be selected from those well known in the art including anionic, nonionic, zwitterionic, amphoteric and cationic surfactants and mixtures thereof.

Particularly suitable surfactants to be used herein are anionic surfactants. Said anionic surfactants are preferred herein as they further contribute to the outstanding stain removal performance of the compositions of the present invention on various types of stains. Moreover they do not stick on carpet, thereby reducing resoiling.

Suitable anionic surfactants include sulfosuccinate surfactants, sulfosuccinamate surfactants, sulfosuccinamide surfactants, alkyl carboxylate surfactants, sarcosinate surfactants, alkyl sulfate surfactants, alkyl sulphonate surfactants, alkyl glycerol sulfate surfactants, alkyl glycerol sulphonate surfactants and mixtures thereof.

Suitable sulfosuccinate surfactants are according to the formula:

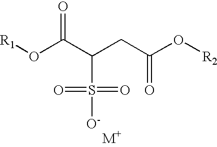

wherein: R₁ is hydrogen or a hydrocarbon group selected from the group consisting of straight or branched alkyl radicals containing from 6 to 20 carbon atoms, preferably 8 to 18 carbon atoms, more preferably 10 to 16 carbon atoms, and alkyl phenyl radicals containing from 6 to 18 carbon atoms in the alkyl group; R₂ is a hydrocarbon group selected from the group consisting of straight or branched alkyl radicals containing from 6 to 20 carbon atoms, preferably 8 to 18 carbon atoms, more preferably 10 to 16 carbon atoms, and alkyl phenyl radicals containing from 6 to 18 carbon atoms in the alkyl group; and M is hydrogen or a cationic moiety, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Such sulfosuccinate surfactants are commercially available under the tradenames Aerosol® from Cytec, Anionyx® from Stepan, Arylene® from Hart, Setacin® from Zschimmer & Schwarz, Mackanate® from Mcintyre and Monawet® from Mona Industries.

Suitable alkyl sulphonate surfactants for use herein include water-soluble salts or acids of the formula RSO₃M wherein R is a C₆-C₂₀ linear or branched, saturated or unsaturated alkyl group, preferably a C₈-C₁₈ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

An example of a C₁₄-C₁₆ alkyl sulphonate is Hostapur® SAS available from Hoechst.

Suitable alkyl sulphate surfactants for use herein are according to the formula R₁SO₄M wherein R₁ represents a hydrocarbon group selected from the group consisting of straight or branched alkyl radicals containing from 6 to 20, preferably 8 to 18, more preferably 10 to 16, carbon atoms and alkyl phenyl radicals containing from 6 to 18 carbon atoms in the alkyl group. M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

By “linear alkyl sulphate or sulphonate” it is meant herein a non-substituted alkyl sulphate or sulphonate wherein the alkyl chain comprises from 6 to 20 carbon atoms, preferably from 8 to 18 carbon atoms, and more preferably from 10 to 16 carbon atoms, and wherein this alkyl chain is sulphated or sulphonated at one terminus.

By “branched sulphonate or sulphate”, it is meant herein an alkyl chain having from 6 to 20 total carbon atoms, preferably from 8 to 18 total carbon atoms, and more preferably from 10 to 16 total carbon atoms, wherein the main alkyl chain is substituted by at least another alkyl chain, and wherein the alkyl chain is sulphated or sulphonated at one terminus.

Particularly preferred branched alkyl sulphates to be used herein are those containing from 10 to 14 total carbon atoms like Isalchem 123 AS®. Isalchem 123 AS® commercially available from Enichem is a C₁₂₋₁₃ surfactant which is 94% branched. This material can be described as CH₃—(CH₂)ₘ13 CH(CH₂OSO₃Na)—(CH₂)ₙ—CH₃ where n+m=8-9. In addition, preferred alkyl sulphates are the alkyl sulphates where the alkyl chain comprises a total of 12 carbon atoms, i.e., sodium 2-butyl octyl sulphate. Such alkyl sulphate is commercially available from Condea under the trade name Isofol® 12S. Particularly suitable liner alkyl sulphonates include C12-C16 paraffin sulphonate like Hostapur® SAS commercially available from Hoechst.

Suitable sulfosuccinamate surfactants for use herein are according to the formula:

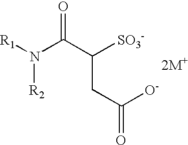

wherein R₁ and R₂ each independently represent a hydrocarbon group selected from the group consisting of straight or branched alkyl radicals containing from 6 to 20, preferably 8 to 18, more preferably 10 to 16, carbon atoms and alkyl phenyl radicals containing from 6 to 18 carbon atoms in the alkyl group. M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable sulfosuccinamide surfactants for use herein are according to the formula:

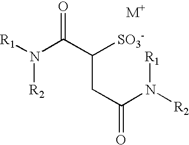

wherein R₁ and R₂ each independently represent a hydrocarbon group selected from the group consisting of straight or branched alkyl radicals containing from 6 to 20, preferably 8 to 18, more preferably 10 to 16, carbon atoms and alkyl phenyl radicals containing from 6 to 18 carbon atoms in the alkyl group. M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl carboxylate surfactants for use herein are according to the formula RCO₂M wherein: R represents a hydrocarbon group selected from the group consisting of straight or branched alkyl radicals containing from 6 to 20, preferably 8 to 18, more preferably 10 to 16, carbon atoms and alkyl phenyl radicals containing from 6 to 18 carbon atoms in the alkyl group. M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable sarcosinate surfactants to be used herein include acyl sarcosinate or mixtures thereof, in its acid and/or salt form, preferably long chain acyl sarcosinates having the following formula:

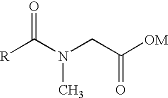

wherein M is hydrogen or a cationic moiety and wherein R is an alkyl group of from 11 to 15 carbon atoms, preferably of from 11 to 13 carbon atoms. Preferred M are hydrogen and alkali metal salts, especially sodium and potassium. Said acyl sarcosinate surfactants are derived from natural fatty acids and the amino-acid sarcosine (N-methyl glycine). They are suitable to be used as aqueous solution of their salt or in their acidic form as powder. Being derivatives of natural fatty acids, said acyl sarcosinates are rapidly and completely biodegradable and have good skin compatibility.

Accordingly, particularly preferred long chain acyl sarcosinates to be used herein include C₁₂ acyl sarcosinate, i.e., an acyl sarcosinate according to the above formula wherein M is hydrogen and R is an alkyl group of 11 carbon atom, sodium N-lauroyl sarcosinate, i.e., an acyl sarcosinate according to the above formula wherein M is sodium and R is an alkyl group of 11 carbon atom, and C₁₄ acyl sarcosinate (i.e., an acyl sarcosinate according to the above formula wherein M is hydrogen and R is an alkyl group of 13 carbon atoms). , sodium N-lauroyl sarcosinate is commercially available, for example, as Hamposyl L-30® supplied by Hampshire or Crodasinic LS30® supplied by Croda. C₁₄ acyl sarcosinate is commercially available, for example, as Hamposyl M-30® supplied by Hampshire or Crodasinic MS30® supplied by Croda.

Suitable nonionic surfactants include amine oxide surfactants. Suitable amine oxide surfactants are according to the formula R₁R₂R₃NO, wherein each of R₁, R₂ and R₃ is independently a saturated substituted or unsubstituted, linear or branched alkyl groups of from 1 to 30 carbon atoms, preferably of from 1 to 20 carbon atoms, and mixtures thereof.

Particularly preferred amine oxide surfactants to be used according to the present invention are amine oxide surfactants having the following formula R₁R₂R₃NO wherein R₁ is a saturated linear or branched alkyl group of from 1 to 30 carbon atoms, preferably of from 6 to 20 carbon atoms, more preferably of from 6 to 16 carbon atoms, and wherein R₂ and R₃ are independently substituted or unsubstituted, linear or branched alkyl groups of from 1 to 4 carbon atoms, preferably of from 1 to 3 carbon atoms, and more preferably are methyl groups. Preferred amine oxide surfactants used herein are pure-cut amine oxide surfactants, i.e., a pure single amine oxide surfactant, e.g. C₈ N,N-dimethyl amine oxide, as opposed to mixtures of amine oxide surfactants of different chain lengths

Suitable amine oxide surfactants for use herein are for instance pure cut C₈ amine oxide, pure cut C₁₀ amine oxide, pure cut C₁₄ amine oxide, natural blend C₈-C₁₀ amine oxides as well as natural blend C₁₂-C₁₆ amine oxides. Such amine oxide surfactants may be commercially available from Hoechst or Stephan.

Suitable nonionic surfactants for use herein also include any ethoxylated C₆-C₂₄ fatty alcohol nonionic surfactant, alkyl propoxylates and mixtures thereof, fatty acid C₆-C₂₄ alkanolamides, C₆-C₂₀ polyethylglycol ethers, polyethylene glycol with molecular weight 1000 to 80000 and glucose amides, alkyl pyrrolidones.

Suitable cationic surfactants for use herein include quaternary ammonium compounds of the formula R₁R₂R₃R₄N+where R₁,R₂ and R₃ are methyl groups, and R₄ is a C₁₂₋₁₅ alkyl group, or where R₁is an ethyl or hydroxy ethyl group, R₂ and R₃ are methyl groups and R₄ is a C₁₂₋₁₅ alkyl group.

Suitable zwitterionic surfactants are zwitterionic betaine surfactants. Suitable zwitterionic betaine surfactants for use herein contain both a cationic hydrophilic group, i.e., a quaternary ammonium group, and anionic hydrophilic group on the same molecule at a relatively wide range of pHs. The typical anionic hydrophilic groups are carboxylates and sulphonates, although other groups like sulfates, phosphonates, and the like can be used. A generic formula for the zwitterionic betaine surfactant to be used herein is;

R₁—N+(R₂)(R₃)R₄X—

wherein R₁ is a hydrophobic group; R₂ is hydrogen, C₁-C₆ alkyl, hydroxy alkyl or other substituted C₁-C₆ alkyl group; R₃ is C₁-C₆ alkyl, hydroxy alkyl or other substituted C₁-C₆ alkyl group which can also be joined to R₂ to form ring structures with the N, or a C₁-C₆ sulphonate group; R₄ is a moiety joining the cationic nitrogen atom to the hydrophilic group and is typically an alkylene, hydroxy alkylene, or polyalkoxy group containing from 1 to 10 carbon atoms; and X is the hydrophilic group, which is a carboxylate or sulphonate group.

Preferred hydrophobic groups R₁ are aliphatic or aromatic, saturated or unsaturated, substituted or unsubstituted hydrocarbon chains that can contain linking groups such as amido groups, ester groups. More preferred R₁ is an alkyl group containing from 1 to 24, preferably from 8 to 18, and more preferably from 10 to 16 carbon atoms. These simple alkyl groups are preferred for cost and stability reasons. However, the hydrophobic group R₁ can also be an amido radical of the formula Rₐ—C(O)—NH—(C(R_{b})₂)m, wherein Rₐ is an aliphatic or aromatic, saturated or unsaturated, substituted or unsubstituted hydrocarbon chain, preferably an alkyl group containing from 8 up to 20, preferably up to 18, more preferably up to 16 carbon atoms, R_{b} is selected from the group consisting of hydrogen and hydroxy groups, and m is from 1 to 4, preferably from 2 to 3, more preferably 3, with no more than one hydroxy group in any (C(R_{b})₂) moiety.

Preferred R₂ is hydrogen, or a C₁-C₃ alkyl and more preferably methyl. Preferred R3 is C₁-C₄ sulphonate group, or a C₁-C₃ alkyl and more preferably methyl. Preferred R₄ is (CH2)ₙ wherein n is an integer from 1 to 10, preferably from 1 to 6, more preferably is from 1 to 3.

Some common examples of betaine/sulphobetaine are described in U.S. Pat. Nos. 2,082,275, 2,702,279 and 2,255,082, incorporated herein by reference.

Examples of particularly suitable alkyldimethyl betaines include coconut-dimethyl betaine, lauryl dimethyl betaine, decyl dimethyl betaine, 2-(N-decyl-N, N-dimethyl-ammonia)acetate, 2-(N-coco N, N-dimethylammonio) acetate, myristyl dimethyl betaine, palmityl dimethyl betaine, cetyl dimethyl betaine, stearyl dimethyl betaine. For example Coconut dimethyl betaine is commercially available from Seppic under the trade name of Amonyl 265®. Lauryl betaine is commercially available from Albright & Wilson under the trade name Empigen BB/L®.

Examples of amidobetaines include cocoamidoethylbetaine, cocoamidopropyl betaine or C₁₀-C₁₄ fatty acylamidopropylene(hydropropylene)sulfobetaine. For example C₁₀-C₁₄ fatty acylamidopropylene(hydropropylene)sulfobetaine is commercially available from Sherex Company under the trade name “Varion CAS® sulfobetaine”.

A further example of betaine is Lauryl-immino-dipropionate commercially available from Rhone-Poulenc under the trade name Mirataine H2C-HA®.

A preferred surfactant for use herein is an anionic surfactant or a zwitterionic surfactant or a mixture thereof, a more preferred surfactant is a sulfosuccinate surfactant, sulfosuccinamate surfactant, sulfosuccinamide surfactant, carboxylate surfactant, sarcosinate surfactant, alkyl sulfate surfactant, alkyl sulphonate surfactant, alkyl glycerol sulfate surfactant, alkyl glycerol sulphonate surfactant or a zwitterionic betaine surfactant and mixtures thereof.

In a preferred embodiment a preferred surfactant for use herein is a sarcosinate surfactant, an alkyl sulphonate surfactant, an alkyl sulphate surfactant, or a zwitterionic betaine surfactant and mixtures thereof, and the most preferred surfactant herein is an alkyl sarcosinate surfactant.

In another preferred a preferred surfactant for use herein is a mixture of a sulfosuccinate surfactant and a second anionic surfactant. More preferably, said surfactant is a mixture of a sulfosuccinate surfactant and a sulphate surfactant. Most preferably, said surfactant is a sulfosuccinate surfactant.

The presence of a surfactant in preferred compositions when employed in the process of cleaning a carpet according to the present invention contributes to the excellent cleaning performance on various types of soils including diffuse soils (e.g., particulate and/or greasy soils) that tend to accumulate in the so called “high traffic areas” but also in delivering good cleaning performance on other types of stains or soils, i.e., proteinic stains like blood.

### Volatile Organic Compounds

As an optional but highly preferred ingredient the compositions according to the present invention may comprise a volatile organic compound (VOC) or a mixture thereof.

Typically, the compositions herein may comprise up to 90%, preferably from 0.1% to 20%, more preferably from 0.5% to 10% and most preferably from 1% to 5% by weight of the total composition of a volatile organic compound or a mixture thereof.

Suitable volatile organic compounds for use herein include aliphatic and/or aromatic alcohol, glycol ethers and/or derivatives thereof, polyol and mixtures thereof.

Suitable aromatic alcohols to be used herein are according to the formula R₁—OH wherein R₁ is an alkyl substituted or non-alkyl substituted aryl group of from 1 to 20 carbon atoms, preferably from 2 to 15 and more preferably from 2 to 10. A suitable aromatic alcohol to be used herein is benzyl alcohol.

Suitable aliphatic alcohols to be used herein are according to the formula R₂—OH wherein R₂ is a linear or branched saturated or unsaturated hydrocarbon chain of from 1 to 20 carbon atoms, preferably from 1 to 10 and more preferably from 2 to 6. Highly preferred herein are aliphatic alcohols with 2 to 4 carbon atoms and most preferably 4 carbon atoms, or mixtures thereof. Suitable aliphatic alcohols to be used herein include linear alcohol like 2-octanol, decanol, isopropyl alcohol, propyl alcohol, ethanol and/or methanol. Highly preferred herein are ethanol, isopropyl alcohol or a mixture thereof.

Ethanol may be commercially available from Eridania Italia under its chemical name.

Isopropanol may be commercially available from Merck/BDH Italia under its chemical name.

Suitable glycol ethers and/or derivatives thereof to be used herein include monoglycol ethers and/or derivatives thereof, polyglycol ethers and/or derivatives thereof and mixtures thereof.

Suitable monoglycol ethers and derivatives thereof to be used herein include n-buthoxypropanol (n-BP), water-soluble CELLOSOLVE® solvents or mixtures thereof. Preferred Cellosolve® solvents include propoxy ethyl acetate salt (i.e., Propyl Cellosolve acetate salt®), ethanol-2-butoxy phosphate salt (i.e., Butyl Cellosolve phosphate salt®), 2-(Hexyloxy)ethanol (i.e., 2-hexyl Cellosolve®), 2-ethoxy ethanol (i.e., 2-ethyl Cellosolve®), 2-butoxyethanol (i.e., 2-buthyl Cellosolve®) or mixtures thereof.

Suitable polyglycol ethers and derivatives thereof to be used herein include n-butoxypropoxypropanol (n-BPP), butyl triglycol ether (BTGE), butyl diglycol ether (BDGE), water-soluble CARBITOL® solvents or mixtures thereof.

Preferred water-soluble CARBITOL® solvents are compounds of the 2-(2-alkoxyethoxy)ethanol class, 2-(2-alkoxyethoxy)propanol class and/or 2-(2-alkoxyethoxy)butanol class wherein the alkoxy group is derived from ethyl, propyl or butyl. A preferred water-soluble carbitol is 2-(2-butoxyethoxy)ethanol also known as butyl carbitol®.

Preferred glycol ethers and/or derivatives thereof are 2-ethoxyethanol, 2-butoxyethanol, n-butoxypropoxypropanol, butyl carbitol® or mixtures thereof.

Suitable polyol solvents to be used herein are the polyols having at least 2 hydroxyl groups (—OH) like diols. Suitable diols to be used herein include 2-ethyl-1,3-hexanediol, 2,2,4-trimethyl-1,3-pentanediol, methyl-2,4 pentanediol or mixture thereof.

The volatile organic compounds, when present, further contribute to the excellent overall cleaning performance of the present invention. Additionally, their addition in the compositions herein also enhances the sanitising properties of the compositions.

### Brightener

The compositions as disclosed herein may comprise as a preferred optional ingredient a brightener.

Brighteners are compounds, which have the ability to fluorescent by absorbing ultraviolet wavelengths of light and re-emitting visible light. Brighteners, also referred to as fluorescent whitening agents (FWA), have been extensively described in the art, see for instance EP-A-0 265 041, EP-A-0 322 564, EP-A-0 317 979 or “Fluorescent whitening agents” by A. K. Sarkar, published by MERROW, especially page 71-72.

Suitable commercially available brighteners can be classified into subgroups, which include, but are not necessarily limited to, derivatives of stilbene, pyrazoline, coumarin, carboxylic acid, methinecyanine, dibenzothiophene-5,5-dioxide, azole, 5- and 6-membered-ring heterocycle, and other miscellaneous agents. Examples of such brighteners are disclosed in “The Production and Application of Fluorescent Brightening Agents”, M. Zahradnik, Published by John Wiley & Sons, New York (1982). Further optical brighteners, which may also be used in the present invention, include naphthlimide, benzoxazole, benzofuran, benzimidazole and any mixtures thereof. Particularly preferred brighteners for use herein are the derivatives of stilbene and mixtures thereof.

Examples of suitable brighteners are those identified in U.S. Pat No. 4,790,856. These brighteners include the PHORWHITE® series of brighteners from Verona. Other brighteners disclosed in this reference include: Tinopal-UNPA®, Tinopal CBS-X® and Tinopal 5BM® available from Ciba Specialty Chemicals; Artic White CC® and Artic White CWD®; the 2-(4-styryl-phenyl)-2H-naptho[1,2-d]triazoles; 4,4′-bis(1,2,3-triazol-2-yl)-stilbenes; 4,4′-bis(styryl)bisphenyls; and the aminocoumarins.

The compositions according to the present invention may comprise from 0.001% to 10%, preferably from 0.005% to 5%, more preferably from 0.005% to 1% and most preferably from 0.008% to 0.5% by weight of the total composition of a brightener or a mixture thereof.

### Anti-Resoiling Agent

The compositions as disclosed herein may comprise as a preferred optional ingredient a further anti-resoiling agent in addition to the fluorinated compound described herein above.

Suitable anti-resoiling agents include anti-resoiling polymers.

Suitable poly (vinyl methyl ether/maleic acid) copolymers are according to the general formula:

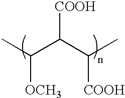

wherein n (degree of polymerisation) is an integer of from 50 to 1600, preferably from 100 to 800, and more preferably from 200 to 400.

Accordingly, suitable poly (vinyl methyl ether/maleic acid) copolymers for use herein have an average molecular weight of from 1′000 to 10′000′000, preferably 10′000 to 1′000′000, more preferably from 10′000 to 500′000, and most preferably from 50′000 to 100′000.

Suitable poly (vinyl methyl ether/maleic acid) copolymers are commercially available, for instance, from ISP Corporation, New York, NY and Montreal, Canada under the product names Gantrez AN Copolymer® (AN-119 copolymer, average molecular weight of 20′000; AN-139 copolymer, average molecular weight of 41′000; AN-149 copolymer, average molecular weight of 50′000; AN-169 copolymer, average molecular weight of 67′000; AN-179 copolymer, average molecular weight of 80′000), Gantrez S® (Gantrez S97®, average molecular weight of 70′000), and Gantrez ES® (ES-225, ES-335, ES-425, ES-435), Gantrez V® (V-215, V-225, V-425).

Preferably the poly (vinyl methyl ether/maleic acid) copolymers are either crosslinked or not crosslinked, i.e., linear. More preferably the poly (vinyl methyl ether/maleic acid) copolymers are not crosslinked.

Suitable anti-resoiling polymers include soil suspending polyamine polymers. Any soil suspending polyamine polymer known to those skilled in the art may also be used herein. Particularly suitable polyamine polymers for use herein are alkoxylated polyamines. Such materials can conveniently be represented as molecules of the empirical structures with repeating units:

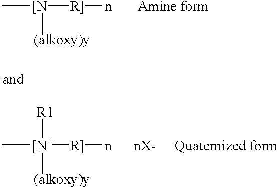

wherein R is a hydrocarbyl group, usually of 2-6 carbon atoms; R₁ may be a C₁-C₂₀ hydrocarbon; the alkoxy groups are ethoxy, propoxy, and the like, and y is from 2 to 30, most preferably from 7 to 20; n is an integer of at least 2, preferably from 2 to 40, most preferably from 2 to 5; and X- is an anion such as halide or methylsulfate, resulting from the quaternization reaction.

The most highly preferred polyamines for use herein are the so-called ethoxylated polyethylene amines, i.e., the polymerized reaction product of ethylene oxide with ethyleneimine, having the general formula:

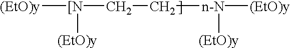

wherein y is from 2 to 50, preferably from 5 to 30, and n is from 1 to 40, preferably from 2 to 40. Particularly preferred for use herein is an ethoxylated polyethylene amine, in particular an ethoxylated polyethylene amine wherein n=2 and y=20, and an ethoxylated polyethylene amine wherein n=40 and y=7.

Suitable ethoxylated polyethylene amines are commercially available from Nippon Shokubai CO., LTD under the product names ESP-0620A® (ethoxylated polyethylene amine wherein n=2 and y=20) or from BASF under the product names ES-8165 and from BASF under the product name LUTENSIT K-187/50® (ethoxylated polyethylene amine wherein n=40 and y=7).

Suitable anti-resoiling polymers also include polyamine N-oxide polymers.

Suitable polyamine N-oxide polymers for use herein are according to the following formula: R—Aₓ—P; containing at least one N-oxide group (N—O group);

wherein: P is a polymerizable unit to which an N—O group can be attached and/or the N—O group can form part of the polymerizable unit;

A is one of the following structures:

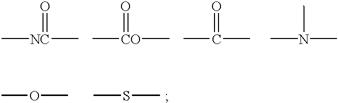

x is 0 or 1;

and R is an aliphatic, ethoxylated aliphatic, aromatic, heterocyclic or alicyclic group or any combination thereof to which the N—O group can be attached to R or the nitrogen of the N—O group is part of R.

By “N—O group” it is meant one of the following general structures:

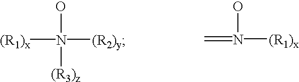

wherein R₁, R₂, R₃ are aliphatic, aromatic, heterocyclic or alicyclic groups or combinations thereof; x, y and z are 0 or 1; and the nitrogen of the N—O group can be attached or form part of any of the aforementioned groups.

Any polymerizable unit P can be used as long as the amine oxide polymer formed is water-soluble and provides the carpet cleaning composition with carpet cleaning and/or carpet anti-resoiling benefits. Preferred polymerizable unit P are vinyl, alkylenes, esters, ethers, amides, imides, acrylates and mixtures thereof. A more preferred polymerizable unit P is vinyl.

Preferred polyamine N-oxide polymers are those wherein R is a heterocyclic group such as pyridine, pyrrole, imidazole, or a derivative thereof, to which the nitrogen of the N—O group can be attached or the N—O group is part of these groups. Most preferred polyamine N-oxide polymers are those wherein R is a pyridine.

The polyamine N-oxide polymer can be obtained in almost any degree of polymerization. Typically, the average molecular weight is within the range of 1,000 to 100,000; more preferred 5,000 to 100,000; most preferred 5,000 to 25,000.

Suitable polyamine N-oxide polymer are polyvinyl pyridine-N-oxide polymers wherein: the polymerizable unit P is vinyl; x=0; and R is pyridine wherein the nitrogen of the N—O group is part of.

Suitable poly vinyl pyridine-N-oxide polymers are commercially available from Hoechst under the trade name of Hoe S 4268®, and from Reilly Industries Inc. under the trade name of PVNO.

Furthermore, suitable anti-resoiling polymers include N-vinyl polymer.

Suitable N-vinyl polymers include polyvinyl pyrrolidone polymers, co-polymers of N-vinylpyrrolidone and N-vinylimidazole, co-polymers of N-vinylpyrrolidone and acrylic acid, and mixtures thereof.

Suitable co-polymers of N-vinylpyrrolidone and N-vinylimidazole polymers (referred to as a class as “PVPVI”) are according to the formula:

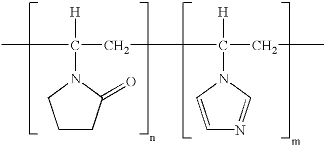

in which n is between 50 and 500 and preferably between 80 and 200 and m is between 50 and 500 and preferably between 80 and 200.

Preferably the PVPVI has an average molecular weight range from 1,000 to 100,000, more preferably from 5,000 to 100,000, and most preferably from 5,000 to 20,000. (The average molecular weight range is determined by light scattering as described in Barth, et al., Chemical Analysis, Vol 113. “Modern Methods of Polymer Characterization”, the disclosures of which are incorporated herein by reference.)

The PVPVI co-polymers typically have a molar ratio of N-vinylimidazole to N-vinylpyrrolidone from 1:1 to 0.2:1, more preferably from 0.8:1 to 0.3:1, most preferably from 0.6:1 to 0.4:1. These co-polymers can be either linear or branched.

Suitable co-polymers of N-vinylpyrrolidone and N-vinylimidazole are commercially available from BASF, under the trade name of Sokalan® PG55.

Suitable polyvinylpyrrolidone (“PVP” ) for use herein are homopolymers of N-vinylpyrrolidone having the following repeating monomer:

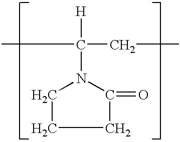

Preferred vinylpyrrolidone homopolymers for use herein have an average molecular weight of from 1,000 to 100,000, preferably from 5,000 to 100,000, and more preferably from 5,000 to 20,000.

Suitable vinylpyrrolidone homopolymers are commercially available from BASF under the trade names Luviskol® K15 (viscosity molecular weight of 10,000), Luviskol® K25 (viscosity molecular weight of 24,000), Luviskol® K30 (viscosity molecular weight of 40,000), and other vinylpyrrolidone homopolymers known to persons skilled in the detergent field (see for example EP-A-262,897 and EP-A-256,696).

Suitable co-polymers of N-vinylpyrrolidone and acrylic acid (referred to as a class as “PV/AA”) are according to the formula:

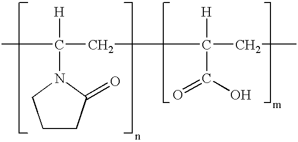

in which n is between 50 and 1000 and preferably between 100 and 200 and m is between 150 and 3000 and preferably between 300 and 600.

Preferably the PV/AA have an average molecular weight range from 1,000 to 100,000, more preferably from 5,000 to 100,000, and most preferably from 5,000 to 25,000.

Suitable co-polymers of N-vinylpyrrolidone and acrylic acid are commercially available from BASF under the trade name Sokalan® PG 310.

Preferred N-vinyl polymers are polyvinyl pyrrolidone polymers, co-polymers of N-vinylpyrrolidone and N-vinylimidazole, co-polymers of N-vinylpyrrolidone and acrylic acid, and mixtures thereof, even more preferred are polyvinyl pyrrolidone polymers.

Suitable anti-resoiling polymers also include soil suspending polycarboxylate polymers.

Any soil suspending polycarboxylate polymer known to those skilled in the art can be used according to the present invention such as homo- or co-polymeric polycarboxylic acids or their salts including polyacrylates and copolymers of maleic anhydride or/and acrylic acid and the like. Indeed, such soil suspending polycarboxylate polymers can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. The presence in the polymeric polycarboxylates herein of monomeric segments, containing no carboxylate radicals such as vinylmethyl ether, styrene, ethylene, etc. is suitable provided that such segments do not constitute more than 40% by weight.

Particularly suitable polymeric polycarboxylates to be used herein can be derived from acrylic acid, including polyacrylic polymers and copolymers of acrylic acid. Most preferred anti-resoiling polymers are copolymer of acrylic acid and methacrylic acid. Such acrylic acid-based polymers, which are useful herein, are the water-soluble salts of polymerized acrylic acid. The average molecular weight of such polymers in the acid form preferably ranges from 2,000 to 10,000, more preferably from 4,000 to 7,000 and most preferably from 4,000 to 5,000. Water-soluble salts of such acrylic acid polymers can include, for example, the alkali metal, ammonium and substituted ammonium salts. Soluble polymers of this type are known materials. Use of polyacrylates of this type in detergent compositions has been disclosed, for example, in Diehl, U.S. Pat. No. 3,308,067, issued Mar. 7, 1967.

Acrylic/maleic-based copolymers may also be used as a preferred soil suspending polycarboxylic polymer. Such materials include the water-soluble salts of copolymers of acrylic acid and maleic acid. The average molecular weight of such copolymers in the acid form preferably ranges from 2,000 to 100,000, more preferably from 5,000 to 75,000, most preferably from 7,000 to 65,000. The ratio of acrylate to maleate segments in such copolymers will generally range from 30:1 to 1:1, more preferably from 10:1 to 2:1. Water-soluble salts of such acrylic acid/maleic acid copolymers can include, for example, the alkali metal, ammonium and substituted ammonium salts. Soluble acrylate/maleate copolymers of this type are known materials, which are described in European Patent Application No. 66915, published Dec. 15, 1982. Particularly preferred is a copolymer of maleic/acrylic acid with an average molecular weight of 70,000. Such copolymers are commercially available from BASF under the trade name SOKALAN® CP5.

Other suitable anti-resoiling polymers include those anti-resoiling polymers having: (a) one or more nonionic hydrophile components consisting essentially of (i) polyoxyethylene segments with a degree of polymerization of at least 2, or (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or (iii) a mixture of oxyalkylene units comprising oxyethylene and from 1 to about 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the soil release agent on such surface, said hydrophile segments preferably comprising at least about 25% oxyethylene units and more preferably, especially for such components having about 20 to 30 oxypropylene units, at least about 50% oxyethylene units; or (b) one or more hydrophobe components comprising (i) C₃ oxyalkylene terephthalate segments, wherein, if said hydrophobe components also comprise oxyethylene terephthalate, the ratio of oxyethylene terephthalate: C₃ oxyalkylene terephthalate units is about 2:1 or lower, (ii) C₄-C₆ alkylene or oxy C₄-C₆ alkylene segments, or mixtures therein, (iii) poly (vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b).

Typically, the polyoxyethylene segments of (a)(i) will have a degree of polymerization of from about 1 to about 200, although higher levels can be used, preferably from 3 to about 150, more preferably from 6 to about 100. Suitable oxy C₄-C₆ alkylene hydrophobe segments include, but are not limited to, end-caps of polymeric soil release agents such as MO₃S(CH₂)ₙOCH₂CH₂O—, where M is sodium and n is an integer from 4-6, as disclosed in U.S. Pat. No. 4,721,580, issued Jan. 26, 1988 to Gosselink.

Anti-resoiling polymers useful in the present invention also include cellulosic derivatives such as hydroxyether cellulosic polymers, co-polymeric blocks of ethylene terephthalate or propylene terephthalate with polyethylene oxide or polypropylene oxide terephthalate, and the like. Such anti-resoiling polymers are commercially available and include hydroxyethers of cellulose such as METHOCELO® (Dow). Cellulosic anti-resoiling polymers for use herein also include those selected from the group consisting of C₁-C₄ alkyl and C₄ hydroxyalkyl cellulose; see U.S. Pat. No. 4,000,093, issued Dec. 28, 1976 to Nicol, et al.

Anti-resoiling polymers characterised by poly(vinyl ester) hydrophobe segments include graft co-polymers of poly(vinyl ester), e.g., C₁-C₆ vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available anti-resoiling polymers of this kind include the SOKALAN ® type of material, e.g., SOKALAN HP-22®, available from BASF.

One type of preferred anti-resoiling polymers is a co-polymer having random blocks of ethylene terephthalate and polyethylene oxide (PEO) terephthalate. The molecular weight of these anti-resoiling polymers is in the range of from about 25,000 to about 55,000. See U.S. Pat. No. 3,959,230 to Hays, issued May 25, 1976 and U.S. Pat. No. 3,893,929 to Basadur issued Jul. 8, 1975.

Another preferred anti-resoiling polymers is a polyester with repeat units of ethylene terephthalate units which contains 10-15% by weight of ethylene terephthalate units together with 90-80% by weight of polyoxyethylene terephthalate units, derived from a polyoxyethylene glycol of average molecular weight 300-5,000. Examples of this polymer include the commercially available material ZELCON 5126® (from Dupont) and MILEASE T® (from ICI). See also U.S. Pat. No. 4,702,857, issued Oct. 27, 1987 to Gosselink.

Another preferred anti-resoiling polymers agent is a sulfonated product of a substantially linear ester oligomer comprised of an oligomeric ester backbone of terephthaloyl and oxyalkyleneoxy repeat units and terminal moieties covalently attached to the backbone. These anti-resoiling polymers are fully described in U.S. Pat. No. 4,968,451, issued Nov. 6, 1990 to J. J. Scheibel and E. P. Gosselink. Other suitable anti-resoiling polymers include the terephthalate polyesters of U.S. Pat. No. 4,711,730, issued Dec. 8, 1987 to Gosselink et al, the anionic end-capped oligomeric esters of U.S. Pat. No. 4,721,580, issued Jan. 26, 1988 to Gosselink, and the block polyester oligomeric compounds of U.S. Pat. No. 4,702,857, issued Oct. 27, 1987 to Gosselink.

Preferred anti-resoiling polymers also include the soil release agents of U.S. Pat. No. 4,877,896, issued Oct. 31, 1989 to Maldonado et al, which discloses anionic, especially sulfoaroyl, end-capped terephthalate esters.

Still another preferred anti-resoiling agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred anti-resoiling agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said anti-resoiling agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof. See U.S. Pat. No. 5,415,807, issued May 16, 1995, to Gosselink et al.

The liquid compositions may comprise from 0.01% to 10%, preferably from 0.01% to 5%, and more preferably from 0.05% to 2% by weight of the total composition of a further anti-resoiling agent.

A preferred anti-resoiling agent is an anti-resoiling polymer. A more preferred anti-resoiling agent is a poly (vinyl methyl ether/maleic acid) copolymer, a soil suspending polyamine polymer, a poly vinyl pyridine-N-oxide polymer or a mixture thereof. An even more preferred anti-resoiling agent is a poly (vinyl methyl ether/maleic acid) copolymer, an alkoxylated polyamine polymer, a poly vinyl pyridine-N-oxide polymer or a mixture thereof. The most preferred anti-resoiling agent useful in the compositions herein are selected from the group consisting of: a poly (vinyl methyl ether/maleic acid) copolymer; an ethoxylated polyethylene amine according to the formula as described above wherein n=2 and y=20; an ethoxylated polyethylene amine according to the formula as described herein wherein n=40 and y=7; a poly vinyl pyridine-N-oxide polymer; and mixtures thereof.

### Radical Scavengers

The compositions herein may comprise a radical scavenger as another optional ingredient. Suitable radical scavengers for use herein include the well-known substituted mono and di hydroxy benzenes and derivatives thereof, alkyl- and aryl carboxylates and mixtures thereof. Preferred radical scavengers for use herein include trimethoxy benzoic acid (TMBA), di-tert-butyl hydroxy toluene (BHT), p-hydroxy-toluene, hydroquinone (HQ), di-tert-butyl hydroquinone (DTBHQ), mono-tert-butyl hydroquinone (MTBHQ), tert-butyl-hydroxy anysole (BHA), p-hydroxy-anysol, benzoic acid, 2,5-dihydroxy benzoic acid, 2,5-dihydroxyterephtalic acid, toluic acid, catechol, t-butyl catechol, 4-allyl-catechol, 4-acetyl catechol, 2-methoxy-phenyl, 2-ethoxy-phenol, 2-methoxy-4-(2-propenyl)phenol, 3,4-dihydroxy benzaldehyde, 2,3-dihydroxy benzaldehyde, benzylamine, 1,1,3-tris(2-methyl-4-hydroxy-5-t-butylphenyl) butane, tert-butyl-hydroxy-anyline, p-hydroxy anyline as well as n-propyl-gallate. Highly preferred for use herein is di-tert-butyl hydroxy toluene, which is for example commercially available from SHELL under the trade name IONOL CP® and/or tert-butyl-hydroxy anysole and/or propyl gallate. These radical scavengers further contribute to the stability of the compositions herein.

Typically, the compositions according to the present invention may comprise up to 5%, preferably from 0.002% to 1.5% by weight and more preferably from 0.002% to 0.5% by weight of the total composition of a radical scavenger.

### Other Optional Ingredients

The compositions herein may further comprise conventional carpet cleaning ingredients. Preferably, the compositions herein may further comprise a number of additional compounds such as stabilising agents, chelating agents, builder systems, perfumes, dyes, suds suppressing agents, enzymes, photobleaching agents, bleach activators and other minors.

### Stabilizing Agents

The compositions of the present invention may further comprise a stabilizing agent selected from the group consisting of hydroxy pyridine N-oxides or derivatives thereof and mixtures thereof.

Suitable hydroxy pyridine N-oxides or derivatives thereof are according to the following formula:

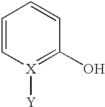

wherein X is nitrogen, Y is one of the following groups oxygen, —CHO, —OH, —(CH₂)n—COOH, wherein n is an integer of from 0 to 20, preferably of from 0 to 10 and more preferably is 0, and wherein Y is preferably oxygen. Accordingly particularly preferred hydroxy pyridine N-oxides or derivatives thereof to be used herein is 2-hydroxy pyridine N-oxide.

Hydroxy pyridine N-oxides or derivatives thereof may be commercially available from Sigma.

Typically, the compositions herein may comprise up to 2%, preferably from 0.001% to 1% and more preferably from 0.001% to 0.5% by weight of the total composition of a hydroxy pyridine N-oxide or derivatives thereof or mixtures thereof.

Chelating Agents

The compositions of the present invention may further comprise a chelating agent.

Suitable chelating agents are those known to those skilled in the art. Particularly suitable chelating agents include for examples phosphonate chelating agents, polyfunctionally-substituted aromatic chelating agents, amino carboxylate chelating agents, other chelating agents like ethylene diamine N,N′- disuccinic acid and mixtures thereof.

Typically, the compositions herein may comprise up to 4%, preferably from 0.001% to 1%, and more preferably from 0.001% to 0.5% by weight of the total composition of a chelating agent.

Suitable phosphonate chelating agents to be used herein may include ethydronic acid, alkali metal ethane 1-hydroxy diphosphonates as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates (DETPMP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy -3,5-disulfobenzene.

A preferred biodegradable chelating agent for use herein is ethylene diamine N,N′- disuccinic acid, or alkali metal, or alkaline earth, ammonium or substitutes ammonium salts thereof or mixtures thereof. Ethylenediamine N,N′- disuccinic acids, especially the (S,S) isomer, have been extensively described in U.S. Pat. No. 4,704,233, Nov. 3, 1987. to Hartman and Perkins. Ethylenediamine N,N′-disuccinic acid is, for instance, commercially available under the tradename ssEDDS® from Palmer Research Laboratories.

Suitable amino carboxylate chelating agents to be used herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanoldiglycines, propylene diamine tetracetic acid (PDTA) and methyl glycine di-acetic acid (MGDA), both in their acid form, or in their alkali metal, ammonium, and substituted ammonium salt forms. A particularly suitable amino carboxylate to be used herein is diethylene triamine penta acetic acid (DTPA).

Other suitable chelating agents to be used herein include salicylic acid or derivatives thereof, or mixtures thereof according to the following formula:

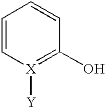

wherein X is carbon, Y is one of the following groups —CHO, —OH, —(CH2)n—COOH, and preferably is —(CH2)n—COOH, and wherein n is an integer of from 0 to 20, preferably of from 0 to 10 and more preferably is 0. Salicylic acid and derivatives thereof may be used herein either in their acid form or in their salts form as for example sodium salts.

Salicylic acid is particularly preferred herein and may be commercially available from Rhone Poulenc.

### Bleach Activators

In an embodiment of the present invention where the compositions herein comprise a peroxygen bleach, preferably hydrogen peroxide, said compositions may further comprise a bleach activator, as an optional ingredient.

By “bleach activator”, it is meant herein a compound which reacts with the peroxygen bleach, preferably hydrogen peroxide, to form a peracid. The peracid thus formed constitutes the activated bleach.

Suitable bleach activators to be used herein include those belonging to the class of esters, amides, imides, or anhydrides. Examples of suitable compounds of this type are disclosed in British Patent GB 1 586 769 and GB 2 143 231 and a method for their formation into a prilled form is described in European Published Patent Application EP-A-62 523. Suitable examples of such compounds to be used herein are tetracetyl ethylene diamine (TAED), sodium 3,5,5 trimethyl hexanoyloxybenzene sulphonate, diperoxy dodecanoic acid as described for instance in U.S. Pat. No. 4,818,425 and nonylamide of peroxyadipic acid as described for instance in U.S. Pat. No. 4,259,201 and n-nonanoyloxybenzenesulphonate (NOBS). Also suitable are N-acyl caprolactam selected from the group consisting of substituted or unsubstituted benzoyl caprolactam, octanoyl caprolactam, nonanoyl caprolactam, hexanoyl caprolactam, decanoyl caprolactam, undecenoyl caprolactam, formyl caprolactam, acetyl caprolactam, propanoyl caprolactam, butanoyl caprolactam pentanoyl caprolactam or mixtures thereof. A particular family of bleach activators of interest was disclosed in EP 624 154, and particularly preferred in that family is acetyl triethyl citrate (ATC). Acetyl triethyl citrate has the advantage that it is environmentally friendly as it eventually degrades into citric acid and alcohol. Furthermore, acetyl triethyl citrate has a good hydrolytical stability in the composition upon storage and it is an efficient bleach activator.

The compositions according to the present invention may comprise up to 30%, preferably from 1% to 20%, and more preferably from 2% to 10% by weight of the total composition of a bleach activator.

### Builders

The compositions according to the present invention may further comprise a builder system. Any conventional builder system known in the art is suitable for use herein. Suitable builders for use herein include derivatives of succinic acid of the formula R—CH(COOH)CH₂(COOH) wherein R is C₁₀₋₂₀ alkyl or alkenyl, preferably C₁₂₋₁₆ alkyl or alkenyl, or wherein R can be substituted with hydroxyl, sulpho sulphoxyl or sulphone substituents. Specific examples include lauryl succinate, myristyl succinate, palmityl succinate, 2-dodecenylsuccinate, 2-tetradecenyl succinate. Succinate builders are preferably used in the form of their water-soluble salts, including sodium, potassium, ammonium and alkanolammonium salts.

Other suitable builders are oxodisuccinates and mixtures of tartrate monosuccinic and tartrate disuccinic acid such as described in U.S. Pat. No.4,663,071.

Further suitable builders for use herein are fatty acid builders including saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid.

The compositions herein may comprise up to 10%, preferably from 1% to 7% by weight of the total composition of a builder system.

### Further Preferred Embodiments

The present invention also encompasses as a preferred embodiment a carpet cleaning composition comprising a fluorinated compound, a peroxygen bleach and a radical scavenger.

It has been found that in peroxygen bleach-containing carpet cleaning composition comprising a fluorinated compound the addition of a radical scavenger provides a significant improvement regarding the chemical stability of said composition.

It is in this preferred embodiment, wherein the composition is not only suitable to be used as a whole carpet cleaner but also as a spotter or a carpet shampoo for use in a carpet extractor machine, as described herein above.

The present invention further encompasses a kit comprising (a) a carpet cleaning composition comprising a fluorinated compound as described herein and (b) a set of instructions to use said composition in a process comprising the steps of applying a carpet cleaning composition onto a carpet using an electrically operated spraying device, leaving said composition to substantially dry onto said carpet and at least partially removing said composition preferably using a vacuum cleaner, wherein said composition comprises a fluorinated compound. Most preferably, said set of instructions specifies that the process comprises steps as described in the section titled “Process of cleaning a carpet” of the present application.

Furthermore, the present invention encompasses the use of a fluorinated compound for the manufacture of a composition for use in the process according to the present invention.

### EXAMPLES

The following examples will further illustrate the present invention. The compositions are made by combining the listed ingredients in the listed proportions (weight % unless otherwise specified). The following Examples are meant to exemplify compositions used in a process according to the present invention but are not necessarily used to limit or otherwise define the scope of the present invention.

| Compositions | | | | | | |
|---|---|---|---|---|---|---|
| (weight %) | I | II | III | IV | V | VI |
| Hydrogen | 2.0 | 4.0 | — | 6.0 | 4.0 | 4.0 |
| peroxide | | | | | | |
| Ethanol | 3.0 | 2.0 | 1.0 | 3.0 | 3.0 | 3.0 |
| Sodium | — | 1.0 | — | — | 1.0 | — |
| Polymeth- | | | | | | |
| acrylate | | | | | | |
| Zonyl 7950 ® | 0.1 | — | — | — | 0.2 | 0.1 |
| Asahi Guard | — | — | 0.2 | 0.1 | — | — |
| AG320A ® | | | | | | |
| Zonyl TBS ® | — | 0.2 | — | 0.1 | — | — |
| Syntran | — | — | 1.0 | — | — | 0.5 |
| 4010E ® | | | | | | |
| PnB | — | 1.0 | — | — | — | — |
| PA | — | 0.1 | — | — | — | 0.1 |
| Dioctyl sodium | — | — | 0.3 | — | 0.5 | — |
| sulphosuccinate | | | | | | |
| Disodium | — | 0.5 | 0.7 | — | 0.5 | — |
| lauryl | | | | | | |
| sulphosuccinate | | | | | | |
| Sodium lauryl | 0.4 | 0.5 | — | 0.4 | — | 0.8 |
| sulfate | | | | | | |
| TMBA | 0.01 | — | — | — | — | — |
| BHT | — | 0.01 | 0.02 | 0.01 | — | 0.01 |
| Na CnAS | — | — | — | 3.0 | 0.5 | — |
| Propyl Gallate | — | — | — | — | 1.0 | — |
| Chelant* | 0.05 | 0.1 | 0.1 | 0.05 | 0.3 | 0.3 |
| Water and | Balance | Balance | Balance | Balance | Balance | Balance |
| minors | | | | | | |
| NaOH or | 4 | 5 | 8 | 4 | 3.5 | 4 |
| H2SO4 | | | | | | |
| up to pH | | | | | | |

Dioctyl sodium sulphosuccinate is commercially available from Cytec under the trade name Aerosol OT®.

Disodium lauryl sulphosuccinate is commercially available from Witco under the trade name Rewopol SBF12®.

Disodium lauramido MEA sulphosuccinate is available from Witco under the trade name Rewopol SBC212P®.

PnB is propylene glycol n-butyl ether commercially available from Arco under the trade name Arcosolv® PNB.

BHT is butylated hydroxy toluene.

TMBA is trimethoxy benzoic acid.

Chelant* is a phosphonate chelant available under the trade name DEQUEST®

Na CnAS is sodium alkyl sulphate.

PA is an ethoxylated tetraethylenepentamine, average molecular weight 12,000.

Zonyl 79500 ® and Zonyl TBS® are fluorosurfactants available from DuPont De Nemours Inc.

Asahi Guard AG320A® is a fluorinated polyurethane.

Syntran 4010E® is a fluorinated acrylate copolymer available from Interpolymer.

The compositions exemplified above are preferably packaged in a container adapted to deliver a spray of droplets. A suitable container used was an electrically driven sprayer.

The compositions in the examples above deliver an excellent carpet anti-resoiling performance benefit as well as excellent cleaning performance on particulate soil, greasy/oily soil, beverage stains and/or proteinic soil as well as on other types of soils.

What is claimed is:

1. A process of cleaning a carpet comprising the steps of applying a liquid carpet cleaning composition onto a carpet using an electrically operated spraying device; leaving said composition to substantially dry onto said carpet; and, at least partially removing said composition, wherein said composition comprises a fluorinated compound or a mixture thereof.

2. A process of cleaning a carpet according to claim 1 wherein said composition is at least partially removed using a vacuum cleaner.

3. A process of cleaning a carpet according to claim 1 wherein said fluorinated compound is selected from the group consisting of: fluoropolymers; and fluorosu rfactants; and mixtures thereof.

4. A process of cleaning a carpet according to claim 3 wherein said fluoropolymers are polymers o r compounds having pendent or end groups of perfluoroalkyl moieties.

5. A process of cleaning a carpet according to claim 4 wherein said fluoropolymers are selected from the group consisting of: fluorinated polyacrylates; fluorinated polymethacrylates; fluorinated copolymers including acrylic and/or methacrylic and/or maleic monomers; fluorinated urethanes; fluorinated polyurethanes; and mixtures thereof.

6. A process of cleaning a carpet according to claim 3 wherein said fluorosurfactants are selected from the group consisting of: fluoroalkyl carboxylates; fluoroalkyl sulphates; fluoroalkyl sulphonates; fluoroalkyl phosphates; fluoroalkyl phosphonates; fluoroalkyl polyethoxyalcohols; fluoroalkyl ammonium; fluoroalkyl betaines or sulphobetaines or other zwitterionic forms; and mixtures thereof.

7. A process of cleaning a carpet according to claim 1 wherein said liquid composition comprises from 0.0001% to 10% by weight of the total composition of said fluorinated compound.

8. A process of cleaning a carpet according to claim 1 wherein said composition further comprises a peroxygen bleach.

9. A process of cleaning a carpet according to claim 8 wherein said composition comprises from 0.01% to 20% by weight of the total composition of said peroxygen bleach.

10. A process of cleaning a carpet according to claim 8 wherein said peroxygen bleach is selected from the group consisting of: hydrogen peroxide; water soluble sources of hydrogen peroxide; organic or inorganic peracids; hydroperoxides; and diacyl peroxides; and mixtures thereof.

11. A process of cleaning a carpet according to claim 1 wherein said composition further comprises a volatile organic compound.

12. A process of cleaning a carpet according to claim 11 wherein said volatile organic compound is selected from the group consisting of: an aliphatic and/or aromatic alcohol; a glycol ethers and/or a derivative thereof; a polyol; and a mixture thereof.

13. A process of cleaning a carpet according to claim 1 wherein said composition further comprises an acid, a base or a mixture thereof.

14. A process of cleaning a carpet according to claim 1 wherein said composition further comprises a surfactant selected from the group consisting of: a sulfosuccinate surfactant; sulfosuccinamate surfactant; sulfosuccinamide surfactant; carboxylate surfactant; sarcosinate surfactant; alkyl sulfate surfactant; alkyl sulphonate surfactant; alkyl glycerol sulfate surfactant; alkyl glycerol sulphonate surfactant; and a zwitterionic betaine surfactant; and mixtures thereof.

15. A process of cleaning a carpet according to claim 1 wherein said composition further comprises a radical scavenger.

16. A carpet cleaning composition comprising a fluorinated compound, a peroxygen bleach, and a radical scavenger.

17. A kit comprising: (a) a carpet cleaning composition comprising a fluorinated compound and (b) a set of instructions to use said composition in a process according to claim 1.
